(19) United States
(12) Patent Application Publication
(10) Pub. No.: US 2023/0288871 A1
(43) Pub. Date: Sep. 14, 2023

(54) TIMEPIECE WITH A ROTATING CONTROL MEMBER

(71) Applicant: MANUFACTURE CONTEMPORAINE DU TEMPS (MCT) SA, Grand-Lancy (CH)

(72) Inventor: Mohamed HILAL, Dubai (AE)

(73) Assignee: MANUFACTURE CONTEMPORAINE DU TEMPS (MCT) SA, Grand-Lancy (CH)

(21) Appl. No.: 18/006,153

(22) PCT Filed: Jul. 19, 2021
(86) PCT No.: PCT/IB2021/056494

§ 371 Date: Jan. 20, 2023

(30) Foreign Application Priority Data
Jul. 21, 2020 (CH) 00903/20

(51) Int. Cl. G04B 3/04; G04B 47/04; G04B 37/10

(52) U.S. Cl. CPC G04B 3/041; G04B 47/044; G04B 37/10

(57) ABSTRACT

The invention relates to a timepiece having a rotary control member, the rotary control member having a hollow cylindrical body coaxial with the axis of rotation of the rotary control member, the hollow cylindrical body defining a hollow inner housing having or supporting a coaxial rotary disc on which is arranged a rotatable mark or logo motif visible from the exterior of the timepiece. The rotary disc rotates freely about its axis in or on the hollow cylindrical body, the rotary disc cooperating with a displacement device comprising an asymmetrically distributed weight to create an imbalance tending to rotate said rotary disc about its axis when the timepiece is in motion or when the control member has been rotated, so that, seen from the outside, the motif maintains a substantially fixed orientation.

### TECHNICAL FIELD

The present invention relates to the field of watchmaking, more particularly to a timepiece comprising a rotary control member including a motif.

For aesthetic reasons, the control members of timepieces and in particular the winding crown include a mark or logo on their external face. The difficulty is to be able to ensure that the control member is brought back to a given orientation with respect to the watch case so as to display the mark or logo in a visible and/or noticeable manner to persons other than the wearer of the timepiece.

### BACKGROUND OF THE INVENTION

EP1411401A1 describes a screw-in crown having a motif such as a logo or mark and wherein the position of the logo or mark affixed to the end face of said crown can be easily adjusted to a given position or orientation after screwing the crown onto the tube.

EP2182417A2 describes a screw-in type watch crown that allows the crown to be oriented to be in a specific position. The screw-in crown comprises a head having a front face provided with a logo of non-circular geometry, a first tube intended to be kinematically connected to the movement, integral with the head and having a thread on its external periphery. The screw-in crown comprises a second tube arranged to receive the first tube, comprising, on the side of the first tube, an internal thread intended to cooperate with the thread of the first tube, and, on the side of the case, a first indexing means. The screw-in crown further comprises a third tube arranged to receive the first and second tubes and comprising a second indexing means cooperating with the first indexing means of the second tube, and a blocking member arranged to block the translational movement of the second tube with respect to the third tube.

JPS5111372 describes a crown formed by caulking a crown with a decorative plate in a drilled hole. A rectangular space is formed between the decorative plate and the bottom of the hole housing a movable member which can move within the space in the direction of the longitudinal force produced under its own weight, and the movable member can be seen from outside the crown.

### OBJECT AND SUMMARY OF THE INVENTION

It is an object of the present invention to provide a timepiece having a rotatable control member having a motif such as a logo or mark and in which the position of the motif affixed to the end face of the control member remains fixed so as to facilitate the reading or visibility of the motif to the wearer or to anyone other than the wearer.

In accordance with the invention, a timepiece comprises a rotary control member, the rotary control member comprising a hollow cylindrical body coaxial with the axis of rotation of the control member, the hollow cylindrical body delimiting a hollow inner housing comprising or supporting a coaxial rotary disc on which is arranged an orientable motif of the mark or logo type visible from outside the timepiece.

The rotary disc rotates freely in a bidirectional manner about its axis in or on the hollow cylindrical body, the rotary disc cooperating with a displacement device comprising a weight, which is asymmetrically distributed in order to create an imbalance tending to cause the rotary disc to rotate about its axis when the timepiece is in motion or when the control member has been rotated, so that, seen from the outside, the motif maintains a substantially fixed orientation.

Preferably and in order to remain in a quasi-fixed position, the displacement device has a bearing belt and a ball bearing integrated in the hollow housing. The bearing belt and the ball bearing are arranged between the asymmetrically distributed weight and the rotary disc.

According to an embodiment, in order to maintain a perfect seal, the timepiece comprises a sealing member arranged in the hollow cylindrical body, the sealing member comprising a fixed disc, parallel to the rotating disc, interposed between the asymmetrically distributed weight and a tube, the fixed disc being driven in, glued or welded.

According to this embodiment, the tube is arranged to fit into a recess disposed in the fixed disc.

### BRIEF DESCRIPTION OF DRAWINGS

The features of the invention will become clearer upon reading the description of several embodiments given only by way of example, in no way limiting, with reference to the schematic figures, in which:

FIG. 1 represents an exploded view of a winding crown that can be arranged on a timepiece according to the present invention;

FIG. 2 represents a cross-sectional view of a winding crown that can be arranged on a timepiece according to the present invention;

FIG. 3 is a perspective view of a winding crown having a logo; and

FIG. 4 represents a cross-sectional view of another embodiment of a winding crown that can be arranged on a timepiece according to the present invention.

### DETAILED DESCRIPTION

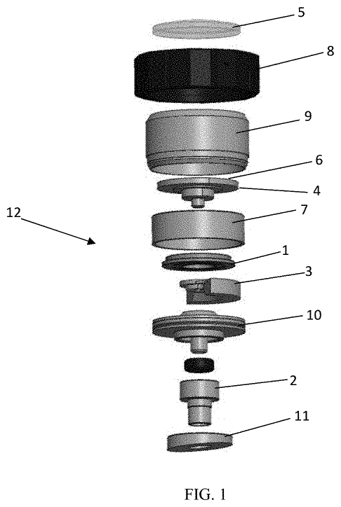

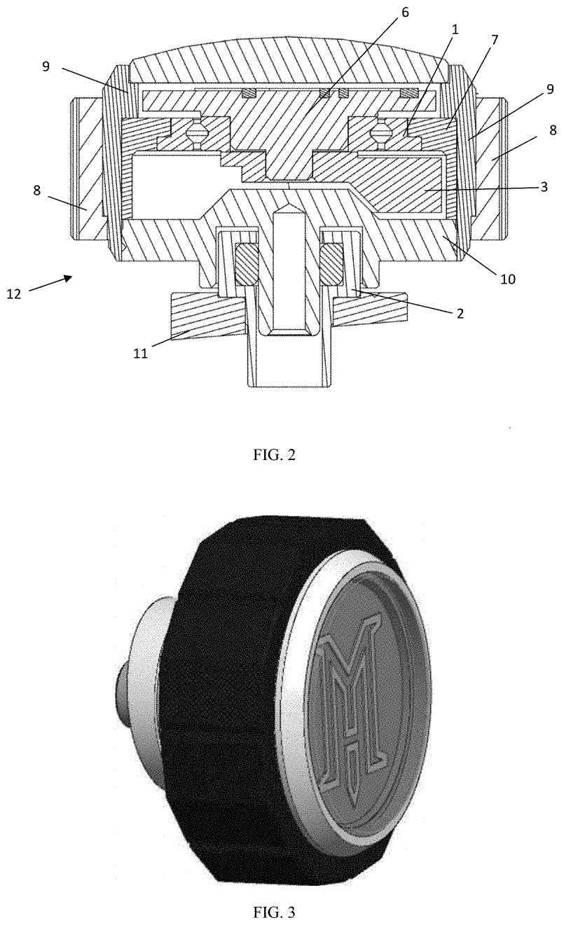

As illustrated in FIG. 1, a rotary control member 12 includes a hollow cylindrical body 9 coaxial with the axis of rotation of the rotary control member 12. The hollow cylindrical body 9 delimits a hollow inner housing comprising a coaxial rotary disc 6 on which is arranged an orientable logo type motif (see FIG. 3) visible from the exterior of the timepiece.

The rotary disc 6 rotates freely about its axis in the hollow cylindrical body, the rotary disc 6 cooperating with a displacement device comprising an asymmetrically distributed weight 3 to create an imbalance tending to cause the rotary disc 6 to rotate about its axis when the timepiece is in motion or when the control member is rotated, so that, seen from the outside, the logo maintains a substantially fixed orientation.

In this example, the displacement device comprises a bearing belt 7 and a ball bearing 1 integrated in the hollow housing, the bearing belt 7 and the ball bearing 1 being arranged between the asymmetrically distributed weight 3 and the rotary disc 6.

A sealing element in the form of a fixed disc 10 is arranged in the hollow cylindrical body 9, the fixed disc 10, parallel to the rotary disc 6, being interposed between the asymmetrically distributed weight 3 and a tube 2, the fixed disc 10 being driven in, glued or welded.

In this example, the tube 2 is arranged to fit into a recess disposed in the fixed disc 10. A beveled washer is attached to the tube 2 by driving-in, gluing or welding.

In the example shown in FIG. 3, a clear glass window is arranged on the hollow cylindrical body 9, so that the rotary disc 6 is visible. In this example, the winding crown rotates freely and can be decorated. This winding crown, configured to have an unbalanced centre of mass, thus creating an imbalance, is driven by gravitational or inertial effect. In this example, a ring 8 surrounds the hollow cylindrical body so as to provide a better grip for a user manipulating the crown.

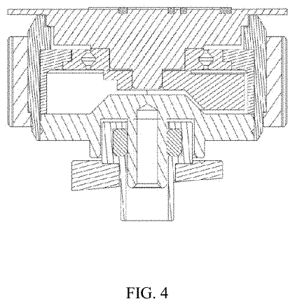

In the example shown in FIG. 4, a rotary control member 12 includes a hollow cylindrical body 9 coaxial with the axis of rotation of the rotary control member 12. The hollow cylindrical body 9 delimits a hollow inner housing supporting a coaxial rotary disc 6 on which is arranged an orientable logo type motif (see FIG. 3) visible from the exterior of the timepiece. The rotary disc 6 rotates freely about its axis on the hollow cylindrical body, the rotary disc 6 cooperating with a displacement device comprising an asymmetrically distributed weight 3 to create an imbalance tending to make the rotary disc 6 rotate about its axis when the timepiece is in motion or when the control member is rotated, so that, seen from the outside, the logo maintains a substantially fixed orientation.

Thus, the rotary disc 6 rotates in a bidirectional manner thanks to the ball bearing allowing the rotary disc 6 to rotate freely with respect to the hollow cylindrical body 9 under the effect of gravitation or inertia.

In the illustrated examples, the rotary disc 6 is integral with an asymmetrically distributed weight 3 extending over an arc of approximately 50% of the circumference of the hollow cylindrical body 9.

What is claimed is:

1. A timepiece comprising a rotary control member, the rotary control member comprising a hollow cylindrical body coaxial with the axis of rotation of the control member, the hollow cylindrical body delimiting a hollow inner housing comprising or supporting a coaxial rotary disc on which is arranged an orientable motif of the mark or logo type visible from outside the timepiece; characterized in that:
said rotary disc rotates freely in a bidirectional manner about its axis in or on the hollow cylindrical body, the rotary disc cooperating with a displacement device comprising an asymmetrically distributed weight to create an imbalance tending to make said rotary disc rotate about its axis when the timepiece is in motion or when the control member is rotated, in such a manner that, seen from the outside, the motif maintains a substantially fixed orientation.

2. The timepiece according to claim 1, wherein the displacement device comprises a bearing belt and a ball bearing integrated in the hollow housing, the bearing belt and the ball bearing being arranged between the asymmetrically distributed weight and the rotatable disc.

3. Timepiece according to claim 1, wherein a sealing member is arranged in the hollow cylindrical body, said sealing member comprising a fixed disc, parallel to the rotary disc, interposed between the asymmetrically distributed weight and a tube, the fixed disc being driven-in, glued or welded.

4. The timepiece according to claim 3, wherein the tube is arranged to fit into a recess disposed in the fixed disc.

5. The timepiece according to claim 3, wherein a beveled washer is secured to the tube by driving-in, gluing or welding.

6. The timepiece according to claim 1, wherein the orientable motif is readable for any movement of the timepiece or the rotary control member or the timepiece.

7. The timepiece according to claim 1, wherein a transparent glass pane is arranged on the hollow cylindrical body, so as to make the rotatable disc visible.

8. The timepiece according to claim 1, in which the rotary disc is integral with an asymmetrically distributed weight extending over an arc comprised between 10% and 60% of the circumference of the hollow cylindrical body.

9. The timepiece according to claim 1, in which the control member is a winding crown.
